(19) United States
(12) Patent Application Publication
(10) Pub. No.: US 2025/0285407 A1
(43) Pub. Date: Sep. 11, 2025

(54) DATA COMPOSITION DETERMINATION APPARATUS, METHOD, AND STORAGE MEDIUM

(71) Applicant: KABUSHIKI KAISHA TOSHIBA, Tokyo (JP)

(72) Inventors: Kazuki Uematsu, Fuchu Tokyo (JP); Takahiro Takimoto, Yokohama Kanagawa (JP); Hideyuki Nakagawa, Kawasaki Kanagawa (JP)

(73) Assignee: KABUSHIKI KAISHA TOSHIBA, Tokyo (JP)

(21) Appl. No.: 19/065,522

(22) Filed: Feb. 27, 2025

(30) Foreign Application Priority Data
Mar. 6, 2024 (JP) 2024-034169

(51) Int. Cl. G06V 10/44; G06T 7/194

(52) U.S. Cl. CPC G06V 10/44; G06T 7/194

(57) ABSTRACT

According to one embodiment, a data composition determination apparatus includes a processor. The processor acquires mixed data to be determined in which data components from a plurality of data sources are included; acquires a model including a plurality of layers from an input layer to an output layer; applies the mixed data to the model to calculate a feature of the mixed data for each of some or all of the layers; and determines a composition of the data sources of the data components constituting the mixed data based on the calculated feature.

### CROSS-REFERENCE TO RELATED APPLICATION

This application is based upon and claims the benefit of priority from Japanese Patent Application No. 2024-034169, filed Mar. 6, 2024, the entire contents of which are incorporated herein by reference.

### FIELD

Embodiments described herein relate generally to a data composition determination apparatus, a method, and a storage medium.

### BACKGROUND

To separate input data including a plurality of mixed data components into individual data components is an important matter that is expected to be applied in various scenes, such as segmentation for dividing an image into each of various objects and backgrounds captured in the image, or signal separation for extracting an abnormal signal buried in noise. In recent years, a more accurate method has been proposed every day by development of a statistical machine learning model, particularly a deep learning model.

However, in order to sufficiently exhibit the performance of the machine learning model, the data used at the time of model learning and the actual processing target data need to belong to the same domain. In particular, in a case where the model is operated for a long period of time, the characteristics of the data gradually change due to the environmental change with the lapse of time, and may exceed the range in which the model appropriately functions. In the case of a deep learning model, it is often difficult to clarify what causes the performance of the model to deteriorate, combined with its black box nature. In particular, in a case of processing input data including data components of a plurality of mixed data sources, there are a plurality of targets that can change with the lapse of time or the like, and thus, it is more important to cope with deterioration associated with a change in data tendency.

### BRIEF DESCRIPTION OF DRAWINGS

FIG. 1 is a diagram showing a hardware configuration example of a data composition determination apparatus.

FIG. 2 is a diagram showing a configuration of mixed data.

FIG. 3 is a diagram showing an example of mixed data.

FIG. 4 is a table showing classifications of data compositions in a case where N=1.

FIG. 5 is a diagram showing a processing procedure of a data composition determination method.

FIG. 6 is a diagram showing a relationship between parts in the data composition determination method shown in FIG. 5.

FIG. 7 is a diagram showing a determination process of six classifications of data compositions.

FIG. 8 is a diagram showing an example of a display screen of a determination result of a data composition.

FIG. 9 is a diagram showing evaluation of determination results of the data compositions according to the present embodiment.

### DETAILED DESCRIPTION

A data composition determination apparatus according to an embodiment includes a first acquisition unit, a second acquisition unit, a calculation unit, and a determination unit. The first acquisition unit acquires mixed data to be determined in which data components from a plurality of mixed data sources are included. The second acquisition unit acquires a model including a plurality of layers from an input layer to an output layer. The calculation unit applies the mixed data to the model to calculate a feature of the mixed data for each of some or all of the layers. The determination unit determines a composition of the data sources of the data components constituting the mixed data based on the calculated feature.

Hereinafter, a data composition determination apparatus, a method, and a program according to the present embodiment will be described with reference to the drawings.

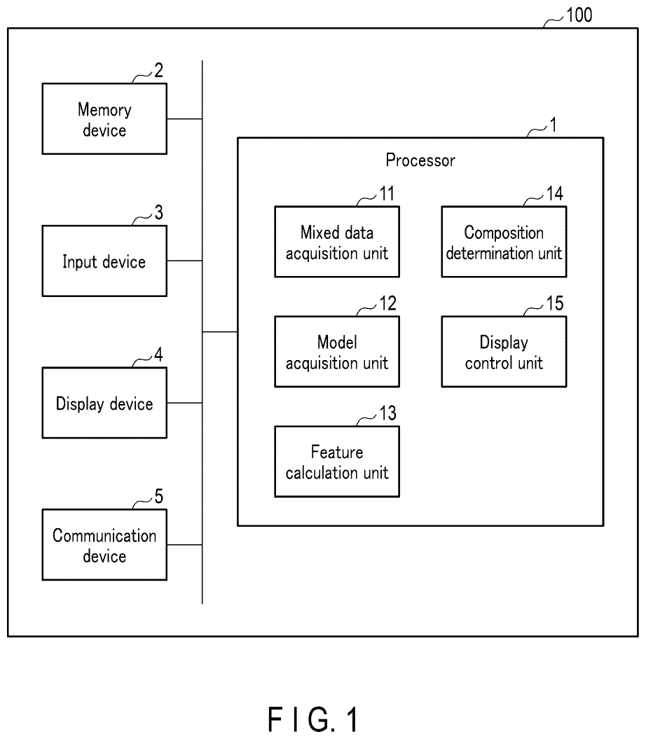

FIG. 1 is a diagram showing a hardware configuration example of a data composition determination apparatus 100. As shown in FIG. 1, the data composition determination apparatus 100 is a computer including a processor 1, a memory device 2, an input device 3, a display device 4, and a communication device 5. Transmission and reception of data and various signals between the processor 1, the memory device 2, the input device 3, the display device 4, and the communication device 5 are performed via a bus.

The processor 1 is an integrated circuit that controls the entire operation of the data composition determination apparatus 100. For example, the processor 1 includes a central processing unit (CPU), a graphics processing unit (GPU), a digital signal processor (DSP), and/or a floating-point unit (FPU). The processor 1 may include an internal memory or an I/O interface. The processor 1 executes various processes by interpreting and calculating a program stored in advance in the memory device 2 or the like. A part or the whole of the processor 1 may be realized by hardware such as an application specific integrated circuit (ASIC) or a field programmable gate array (FPGA).

The memory device 2 is a volatile memory and/or a nonvolatile memory that stores various data. For example, the memory device 2 stores data and setting values used in a case where the processor 1 executes the various processes, data generated in the various processes by the processor 1, and the like. The memory device 2 includes a read only memory (ROM), a random access memory (RAN), a hard disk drive (HDD), a solid state drive (SSD), an integrated circuit memory device, and the like. Note that the memory device 2 may include a non-transitory computer-readable storage medium that stores the program executed by the processor 1.

The input device 3 receives inputs of various operations from an operator. As the input device 3, a keyboard, a mouse, various switches, a touch pad, a touch panel display, and the like can be used. An electric signal (hereinafter, an operation signal) corresponding to the input of the received operation is supplied to the processor 1.

The display device 4 displays various data under the control of the processor 1. As the display device 4, a cathode-ray tube (CRT) display, a liquid crystal display, an organic electro luminescence (EL) display, a light-emitting diode (LED) display, a plasma display, or any other display can be appropriately used. The display device 4 may be a projector.

The communication device 5 includes a communication interface such as a network interface card (NIC) for performing data communication with various devices connected to the data composition determination apparatus 100 via a network. Note that an operation signal may be supplied from a computer connected via the communication device 5 or an input device included in the computer, or various data may be displayed on a display device or the like included in the computer connected via the communication device 5. However, in order to simplify the following description, unless otherwise specified, it is assumed that the supply source of the operation signal is the input device 3 and the display destination of various data is the display device 4. The input device 3 can be replaced with a computer connected via the communication device 5 or an input device included in the computer, and the display device 4 can be replaced with a display device or the like included in the computer connected via the communication device 5.

The data composition determination apparatus 100 does not need to include all of the processor 1, the memory device 2, the input device 3, the display device 4, and the communication device 5. Some of the memory device 2, the input device 3, the display device 4, and the communication device 5 may not be provided according to the design. The data composition determination apparatus 100 may be provided with any additional hardware device useful for executing the processing according to the present embodiment. The data composition determination apparatus 100 does not need to be physically configured by one computer, and may be configured by a computer system including a plurality of computers communicably connected via a wired or network line or the like. The allocation of the series of processes according to the present embodiment to a plurality of processors 1 mounted on the computers can be arbitrarily set. All the processors 1 may execute all the processes in parallel, or a specific process may be assigned to one or some of the processors 1, and a series of processes according to the present embodiment may be executed as the entire computer system.

As shown in FIG. 1, the processor 1 functions as a mixed data acquisition unit 11, a model acquisition unit 12, a feature calculation unit 13, a composition determination unit 14, and a display control unit 15 by executing the program.

The mixed data acquisition unit 11 acquires various mixed data. The “mixed data” represents data that includes data components from a plurality of mixed data sources. The “data” includes image data that is data of a series of pixel values, audio data that is series data of amplitude of an audio signal, text data that is data of a series of characters, numbers, signs, and the like, sensor data that is data of a series of output values of a sensor, and the like. As the sensor, a voltage sensor, a current sensor, a power sensor, a vibration sensor, a magnetic sensor, a weight sensor, a speed sensor, an acceleration sensor, a distance sensor, or any other sensor that measures any physical quantity can be applied. The “data source” represents a generation source of various data components included in the data.

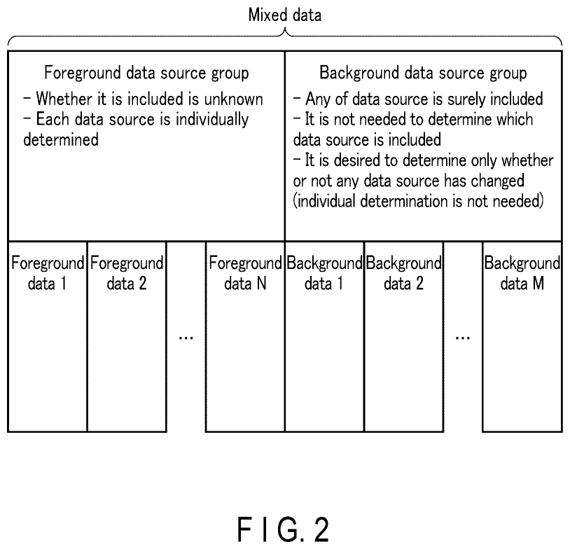

FIG. 2 is a diagram showing a configuration of the mixed data. As shown in FIG. 2, each of the data sources included in the mixed data belongs to one of a foreground data source group and a background data source group. The foreground data source group includes N-number of foreground data sources (N is a natural number of zero or more). In the foreground data source group, each of the N-number of foreground data sources is individually determined whether or not a data component of the foreground data source is included in the mixed data and whether or not a tendency of the data component of the foreground data source has changed. As an example, an abnormal portion appearing in the image data or an abnormal component included in the time-series data corresponds to a data component of the foreground data source. The abnormal component occurs unsteadily during the measurement period of the mixed data. A situation where it is desired to individually determine the data components of all the data sources that can be included in the mixed data corresponds to a case where all the data sources belong to the foreground data source group.

As shown in FIG. 2, the background data source group includes M-number of background data sources (M is a natural number of one or more). The data component of the background data source constantly occurs during the measurement period of the mixed data. In the background data source group, each of the M-number of background data sources is not individually determined whether or not a data component of the background data source is included in the mixed data, but it is determined whether or not a tendency of any data component of the M number of background data sources has changed. As an example, a background component inevitably included the image data, a noise component always included in the time-series data, and the like are not individually determined, but it is sufficient to recognize whether or not some change has occurred as a whole. Assuming such a situation, it is known in advance that any one of the data sources is always included in the mixed data, and it is not needed to determine whether or not those data sources are included, but a group of data sources in which it is needed to determine whether or not any data source has changed is the background data source group. Since it is not needed to grasp the detailed breakdown of the background data source group, it may be considered that all the background data source groups may collectively constitute one data source. For example, this corresponds to a situation in which the sky and the forest are not distinguished from each other in the background in the image data and are collectively processed as the background, or a situation in which a plurality of types of noise components included in the time-series data are not distinguished and are collectively processed as one type of noise component. Considering as above, the situation in which all the data sources that can be included in the mixed data belong to the background data source group is equivalent to detecting a tendency change for one type of data input.

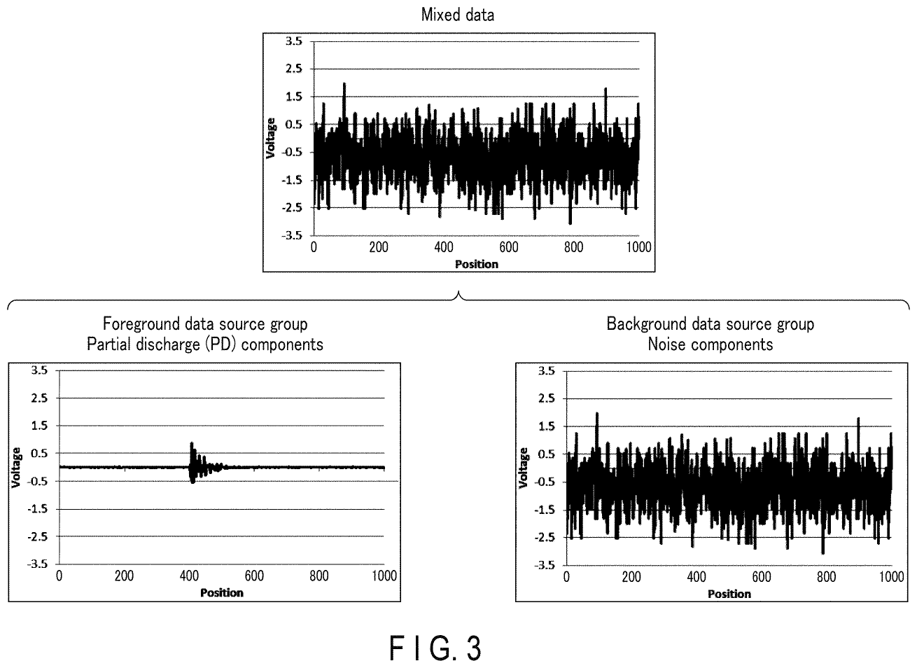

FIG. 3 is a diagram showing an example of the mixed data. In FIG. 3, the mixed data is sensor data from a voltage sensor that detects discharge, and is data indicating a change of a voltage value (Voltage) for each position (Position). The mixed data includes a partial discharge (PD) component and a noise component. That is, the mixed data shown in FIG. 3 is an example of a case where N=1 and M=1. The partial discharge component is classified as a foreground data source group, and is a data component having a generation source of the partial discharge as a foreground data source. The noise component is classified into a background data source group, and is a data component having a noise generation source as a background data source. The noise component constantly occurs during the measurement period of the mixed data. The partial discharge component is a minute nonstationary data component buried in a strong noise component, and has stronger localization than the noise component. The partial discharge component unsteadily occurs during the measurement period of the mixed data. The mixed data may include a data component of another foreground data source or a data component of another background data source. Which data source is used as the foreground data source or the background data source can be arbitrarily set according to the interest.

As another example, the mixed data may be image data showing a city scene. In this case, the mixed data includes, as an example, data components of a person, a building, a road, the sky, and the like, and the data component of the person is foreground data having the person as a foreground data source, and the data component of the building is foreground data having the building as a foreground data source. In addition, the data component of the road is background data having the road as a background data source, and the data component of the sky is background data having the sky as a background data source.

As another example, the mixed data may be text data related to a plurality of topics. In this case, the mixed data includes sentences describing a plurality of topics, and the data components of various words are foreground data having the word as a foreground data source, the data component of the preposition is background data having the preposition as a background data source, and the data component of the context is background data having the context as a background data source.

Specifically, the mixed data acquisition unit 11 acquires mixed data to be determined in which data components from a plurality of data sources are included. The mixed data to be determined represents data in which the composition of the data components is unknown. In addition, the mixed data acquisition unit 11 acquires, for each of a plurality of foreground data sources, first other mixed data in which a data source other than the foreground data source is dominant and second other mixed data in which the foreground data source is dominant. In this case, it is assumed that the mixed data acquisition unit 11 generates each of the first other mixed data and the second other mixed data based on the known mixed data.

The model acquisition unit 12 acquires a model including a plurality of layers from an input layer to an output layer. The model is based on a deep learning model that is a multilayered machine learning model that is trained to perform specific information processing. The type of the information processing is not particularly limited as long as the feature extraction of the input data is performed, and as an example, noise reduction (denoise), defect extraction, segmentation, sound source separation, related sentence search, and the like can be used.

The feature calculation unit 13 applies the determination target mixed data acquired by the mixed data acquisition unit 11 to the model of the model acquisition unit 12, and calculates the feature of the mixed data for each of some or all of the layers. Similarly, the feature calculation unit 13 also applies each of the first other mixed data and the second other mixed data acquired by the mixed data acquisition unit 11 to the model, and calculates the feature of the mixed data for each of some or all of the layers.

The composition determination unit 14 determines the composition of the data source of the data component constituting the mixed data to be determined (hereinafter, data composition) based on the features calculated by the feature calculation unit 13. Specifically, the composition determination unit 14 includes a signal source determination module, a first change detection module, and a second change detection module. The signal source determination module determines, for each of the one or more foreground data sources, whether or not the foreground data source is included in the mixed data based on the feature from a first designated layer among the layers. The first change detection module determines, for each of the one or more foreground data sources, whether or not the tendency of the data component of the foreground data source included in the mixed data has changed based on the feature from a second designated layer among the layers. The second change detection module determines whether or not the tendency of the data component of sources other than the foreground data source included in the mixed data has changed based on the feature from a third designated layer among the layers, integrates the determination results based on the feature from the third designated layer regarding one or more foreground data sources, and determines whether or not the tendency of the data component of the background data source group included in the mixed data has changed.

The data composition is classified based on a combination of whether or not the foreground data source is included in the mixed data (determination result D1), whether or not the tendency of the data component of the foreground data source has changed (determination result D2), and whether or not the tendency of the data component of the background data source group included in the mixed data has changed (determination result D3).

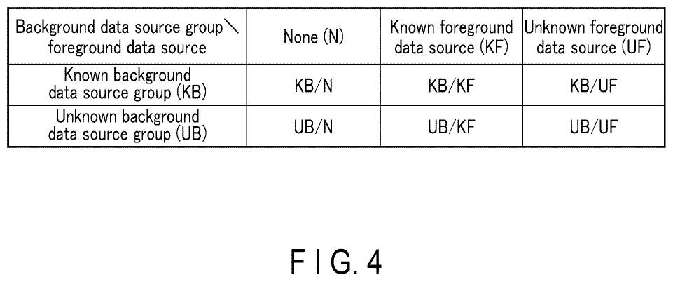

FIG. 4 is a table showing, in a tabular form, classifications of data compositions in a case where N=1. As shown in FIG. 4, the data composition is classified into six data compositions based on a combination of determination results D1, D2, and D3. Specifically, the mixed data is classified into a first composition (KB/N) in which only the data component of the known background data source group is included in the mixed data (the data component of the foreground data source is not included), a second composition (KB/KF) in which the data component of the known background data source group and the data component of the known foreground data source are included in the mixed data, a third composition (KB/UF) in which the data component of the known background data source group and the data component of the unknown foreground data source are included in the mixed data, a fourth composition (UB/N) in which only the data component of the unknown background data source group is included in the mixed data (the data component of the foreground data source is not included), a fifth composition (UB/KF) in which the data component of the unknown background data source group and the data component of the known foreground data source are included in the mixed data, and a sixth composition (UB/UF) in which the data component of the unknown background data source group and the data component of the unknown foreground data source are included.

The first composition (KB/N) corresponds to a case where it is determined that there is no foreground data source as the determination result D1 and the background data source group is known as the determination result D3. Note that, regarding the determination result D3, a change in the tendency of the data component of the background data source group means that the background data source group is an unknown background qualitatively different from a known background, and a non-change in the tendency of the data component of the background data source group means that the background data source group is of the same quality as the known background. The second composition (KB/KF) corresponds to a case where it is determined that there is a foreground data source as the determination result D1, the foreground data source is known as the determination result D2, and the background data source group is known as the determination result D3. Note that, regarding the determination result D2, a change in the tendency of the data component of the foreground data source means that the foreground data source is unknown, and a non-change in the tendency of the data component of the foreground data source means that the foreground data source is known.

Similarly, the third composition (KB/UF) corresponds to a case where it is determined that there is a foreground data source as the determination result D1, the foreground data source is unknown as the determination result D2, and the background data source group is known as the determination result D3. The fourth composition (UB/N) corresponds to a case where it is determined that there is no foreground data source as the determination result D1 and that the background data source group is unknown as the determination result D3. The fifth composition (UB/KF) corresponds to a case where it is determined that there is a foreground data source as the determination result D1, the foreground data source is known as the determination result D2, and the background data source group is unknown as the determination result D3. The sixth composition (UB/UF) corresponds to a case where it is determined that there is a foreground data source as the determination result D1, the foreground data source is unknown as the determination result D2, and the background data source group is unknown as the determination result D3. The data composition in general N is classified into 2×3^{N} ways based on a combination of 2N+1 determination results.

The display control unit 15 displays various types of information. As an example, the display control unit 15 displays the data composition determined by the composition determination unit 14 on the display device 4. As another example, the display control unit 15 may display the mixed data as a determination target acquired by the mixed data acquisition unit 11, the first other mixed data and/or the second other mixed data on the display device 4.

Next, an operation example of the data composition determination apparatus 100 according to the present embodiment will be described.

In the following embodiment, it is assumed that the mixed data includes a foreground data source group and a background data source group. It is considered a case where there are two or more data sources in the foreground data source group, or a case where there are one or more data sources in each of the foreground data source group and the background data source group. However, even in the case of other conditions, the composition of the mixed data can be determined by the following method.

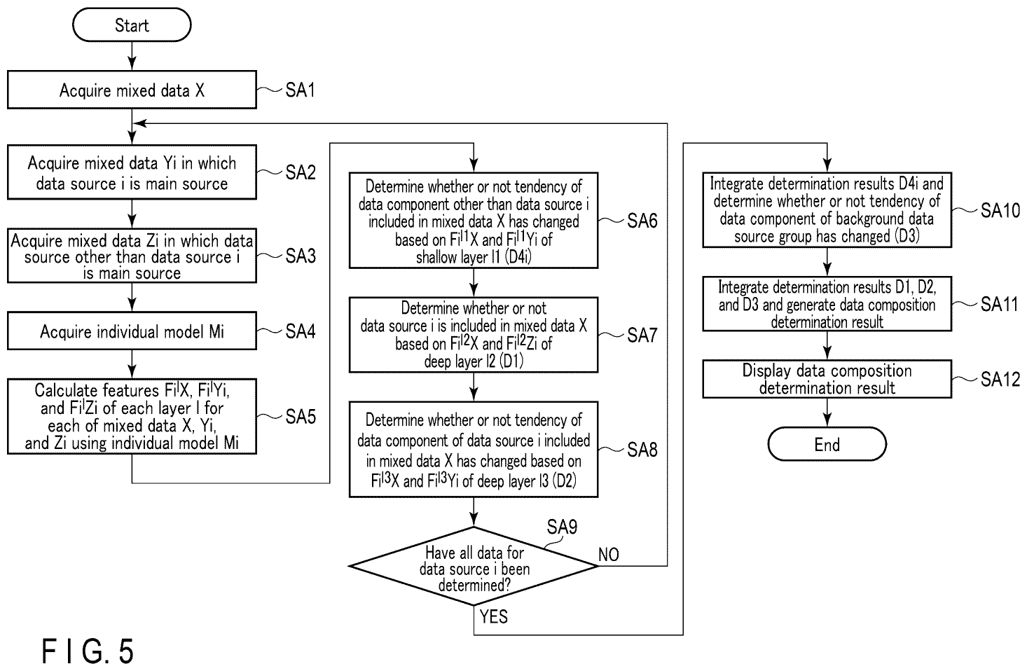

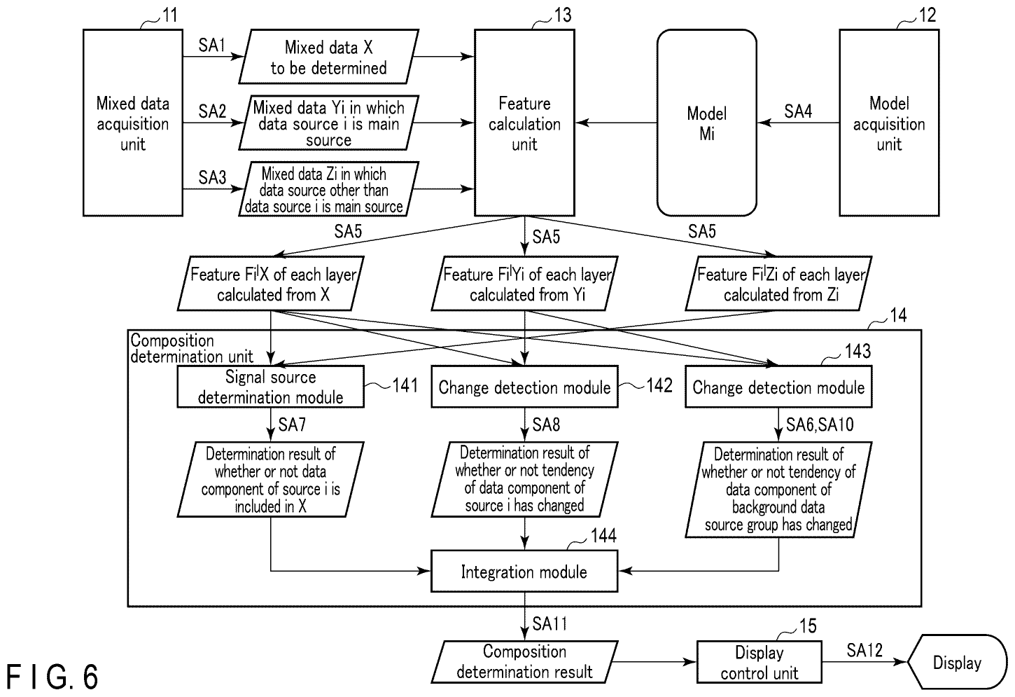

FIG. 5 is a diagram showing a processing procedure of a data composition determination method by the processor 1. FIG. 6 is a diagram showing a relationship between parts in the data composition determination method shown in FIG. 5. As shown in FIGS. 5 and 6, the mixed data acquisition unit 11 acquires mixed data X to be determined (step SA1). The mixed data X includes a data component of a data source belonging to the foreground data source group and a data component of a data source belonging to the background data source group. A plurality of pieces of mixed data X may be acquired.

In a case where step SA1 is performed, the mixed data acquisition unit 11 acquires mixed data Yi in which the data source i is a main component (step SA2). Here, the data source i indicates a foreground data source to be determined. The foreground data source to be determined is selected according to an arbitrary rule from among one or more predetermined foreground data sources that can be included in the foreground data source group. The following steps SA2 to SA9 are repeated for each data source i.

Acquisition of the mixed data Yi will be specifically described. The memory device 2 stores a large number of pieces of known data related to a large number of data sources. These pieces of known data are assumed to have been used for training on an individual model Mi of the data source i. The mixed data acquisition unit 11 generates the mixed data Yi by arbitrarily combining the pieces of known data stored in the memory device 2. As an example, a combination of data sources designated such that the data source i is the main component is determined by a user or the like. The designated combination includes a data source i and a data source other than the data source i, and the distribution of the data source i and the other data sources may be arbitrarily decided such that the data source i may be the most dominant component and the background data source may be the second dominant component. Next, the mixed data acquisition unit 11 reads known data corresponding to the combination from the memory device 2 and combines the read known data. With this configuration, the mixed data acquisition unit 11 generates the mixed data Yi in which the data source i is the main is main component. The mixed data Yi corresponds to data before the tendency changes. The mixed data Yi corresponds to the second other mixed data. A plurality of pieces of mixed data Yi may be generated within a range satisfying the above condition.

In a case where step SA2 is performed, the mixed data acquisition unit 11 acquires mixed data Zi in which especially the background data source group, other than the data source i, is the main component (step SA3). As in the mixed data Yi, the mixed data Zi can also be generated by arbitrarily combining pieces of known data stored in the memory device 2. The combination of the data sources may be configured such that the background data source is a main component. A data source i may be included. The mixed data Zi corresponds to data before the tendency changes. The mixed data Zi corresponds to the first other mixed data. A plurality of pieces of mixed data Zi may be generated within a range satisfying the above condition.

In a case where step SA3 is performed, the model acquisition unit 12 acquires the individual model Mi (step SA4). The individual model Mi is provided for each of one or more data sources i to be determined. The individual model Mi is a trained deep learning model having an input layer, a hidden layer, and an output layer. The number of layers L of hidden layers is at least two or more. The deep learning model extracts features stepwise by processing in a multi-layered L layer. The individual model Mi is trained based on the known data of each data source i in order to extract the features of each data source i from the mixed data X, Yi, and Zi. The training method can be arbitrarily selected from any method such as supervised learning, semi-supervised learning, contrastive learning, and unsupervised learning. As an example, the individual model Mi is optimized based on the known data of the corresponding data source i so as to maximize the matching degree with the information held by the corresponding data source i. Therefore, the individual model Mi is provided for each foreground data source i and optimized for each foreground data i. The individual model Mi is stored in the memory device 2 in association with an identifier of the data source i. The model acquisition unit 12 reads the individual model Mi associated with the identifier of the data source i from the memory device 2. As a result, the individual model Mi is acquired.

In a case where step SA4 is performed, the feature calculation unit 13 calculates features Fi¹X, Fi¹Yi, and Fi¹Zi of each layer 1 (1 is a natural number from one to L) for each of the mixed data X, Yi, and Zi using the individual model Mi acquired in step SA4 (step SA5). For example, the feature calculation unit 13 inputs the mixed data X to the individual model Mi, performs a feature calculation for each layer 1 from the first layer to the L-th layer, and calculates the feature Fi¹X. Similarly for the mixed data Yi and Zi, the feature calculation is performed for each layer 1 from the first layer to the L-th layer, and the features Fi¹Yi and Fi¹Zi are calculated. As described above, the feature calculation unit 13 can calculate the features Fi¹X, Fi¹Yi, and Fi¹Zi having various characteristics using the multilayered property of the individual model Mi.

In a case where step SA5 is performed, the composition determination unit 14 determines whether or not the tendency of the data components other than the data source i included in the mixed data X has changed based on the features Fi¹¹X and Fi¹¹Yi of a shallow layer 11 (step SA6). Specifically, the composition determination unit 14 acquires the features Fi¹¹X and Fi¹¹Yi of the shallow layer 11 designated in advance from the features Fi¹X and Fi¹Yi calculated in step SA5. The shallow layer 11 represents a layer closer to the input than a reference layer among the L-number of layers. The reference layer can be arbitrarily designated, but for example, may be designated as L/2, L/3, or the like. The number of shallow layers 11 and the number of inputs X and Yi may be one or plural. The features Fi¹¹X and Fi¹¹Yi tend to be dominated by feature components of data components other than the data source i.

Next, the second change detection module 143 of the composition determination unit 14 calculates an evaluation score for evaluating the difference between the features Fi¹¹X and Fi¹¹Yi (hereinafter, referred to as a first evaluation score) based on the features Fi¹¹X an Fi¹¹Yi, and determines whether or not the tendency of the data component of the sources other than foreground data source included in the mixed data X has changed based on the comparison between the first evaluation score and a threshold (hereinafter, referred to as a first threshold). As the first evaluation score, the degree of divergence between the features Fi¹¹X and Fi¹¹Yi (hereinafter, referred to as a first divergence degree) is used. The second change detection module 143 determines that the tendency of the data components other than the foreground data source i included in the mixed data X has changed in a case where the first divergence degree is larger than the first threshold, and determines that the tendency of the data components other than the foreground data source i included in the mixed data X has not changed in a case where the first deviation degree is smaller than the first threshold.

The type of the first divergence degree can be arbitrarily selected according to a combination of the number of features Fi¹¹X and the number of features Fi¹¹Yi. The number of each of the features Fi¹¹X and Fi¹¹Yi can be arbitrarily set according to the number of layers of the shallow layer 11 and the number of input data. In other words, if the number of layers, X, and Yi of the shallow layer 11 is one, the number of the features Fi¹¹X and Fi¹¹Yi is one, and if any of the number of layers, X, and Yi of the shallow layer 11 is more than one, the number of the features Fi¹¹X and Fi¹¹Yi is one or more. Specifically, in a case where the number of features Fi¹¹X is one and the number of features Fi¹¹Yi is one, the Euclidean distance, the Manhattan distance, the cosine similarity, and the like may be selected as the divergence degree. In a case where the number of features Fi¹¹X is one and the number of features Fi¹¹Yi is plural, or in a case where the number of features Fi¹¹X is plural and the number of features Fi¹¹Yi is one, the Mahalanobis distance, the Gaussian mixture model, the kernel density estimation, or the like may be selected as the divergence degree. In a case where there are a plurality of features Fi¹¹X and there are a plurality of features Fi¹¹Yi, the maximum mean discrepancy (MMD), the Kullback-Leibler divergence, and the like may be selected as the degree of divergence.

As the first threshold, a unique threshold embedded in the composition determination unit 14 may be used. Alternatively, a threshold designated by a user or the like may be used as the first threshold. The composition determination unit 14 may calculate the first threshold based on the known data and evaluation data used at the time of training the individual model Mi.

In a case where step SA6 is performed, the composition determination unit 14 determines whether or not the data source i is included in the mixed data X based on the features Fi¹²X and Fi¹²Zi of a deep layer 12 (step SA7). Specifically, the composition determination unit 14 acquires a feature Fi¹²X and a feature Fi¹²Zi of a previously designated deep layer 12 from the features Fi¹X and Fi¹Zi calculated in step SA5. The deep layer 12 means a layer closer to the output than the reference layer among the L-number of layers. The reference layer can be arbitrarily designated, but may be designated as L/2, 2L/3, or the like, for example. The number of layers of the deep layer 12 and the number of inputs X and Zi may be one or plural. The features Fi¹²X and Fi¹²Zi tend to be dominated by the feature components of the data components of the data source i.

Next, the signal source determination module 141 of the composition determination unit 14 calculates an evaluation score for evaluating a difference between the features Fi¹²X and Fi¹²Zi (hereinafter, referred to as a second evaluation score) based on the features Fi¹²X and Fi¹²Zi, and determines whether or not the foreground data source i is included in the mixed data X based on comparison between the second evaluation score and a threshold (hereinafter, referred to as a second threshold). As the second evaluation score, the degree of divergence (hereinafter, referred to a second divergence degree) between the features Fi¹²X and Fi¹²Zi, or a residual from the temporal and/or spatial average of the feature Fi¹²X is used. The signal source determination module 141 determines that the foreground data source i is included in the mixed data X in a case where the second evaluation score is larger than the second threshold, and determines that the foreground data source i is not included in the mixed data X in a case where the second evaluation score is smaller than the second threshold.

The type of the second divergence degree can be arbitrarily selected according to a combination of the number of features Fi¹²X and the number of features Fi¹²Zi. The number of each of the features Fi¹²X and Fi¹²Zi can be arbitrarily set according to the number of layers of the deep layer 12 and the number of input data. In other words, in a case where the number of layers, X, and Zi of the deep layer 12 is one, the number of the features Fi¹²X and Fi¹²Zi is one, and in a case where any of the number of layers, X, and Zi of the deep layer 12 is more than one, the number of the features Fi¹²X and Fi¹²Zi is one or more. Specifically, in a case where the number of features Fi¹²X is one and the number of features Fi¹²Zi is one, the Euclidean distance, the Manhattan distance, the cosine similarity, and the like may be selected as the divergence degree. In a case where the number of features Fi¹²X is one and the number of features Fi¹²Zi is plural, or in a case where the number of features Fi¹²X is plural and the number of features Fi¹²Zi is one, the Mahalanobis distance, the Gaussian mixture model, the kernel density estimation, or the like may be selected as the divergence degree. In a case where the number of features Fi¹²X is plural and the number of features Fi¹²Zi is plural, the maximum mean discrepancy, the Kullback-Leibler divergence, and the like may be selected as the divergence degree.

As the residual from the temporal and/or spatial average of the feature Fi¹²X, a principal component analysis or a Mahalanobis distance of the feature Fi¹²X is used. The principal component analysis utilizes a product of residuals, that is, a degree of divergence from a low-dimensional space defined by a covariance matrix. The Mahalanobis distance represents a Euclidean distance from the average, normalized with a covariance matrix. Note that the feature Fi¹²X may be mixed data X itself.

As the second threshold, a unique threshold embedded in the composition determination unit 14 may be used. Alternatively, a threshold designated by a user or the like may be used as the second threshold. The composition determination unit 14 may calculate the second threshold based on the known data used at the time of training the individual model Mi and a small number of pieces of evaluation data.

In a case where step SA7 is performed, the composition determination unit 14 determines whether or not the tendency of the data component of the data source i included in the mixed data X has changed based on the features Fi¹³X and Fi¹³Yi of the deep layer 13 (step SA8). Step SA8 may be performed only in a case where it is determined in step SA7 that the foreground data source i is included in the mixed data X. Specifically, the composition determination unit 14 acquires the features Fi¹³X and Fi¹³Yi of the previously designated deep layer 13 from the features Fi¹X and Fi¹Yi calculated in step SA5. The deep layer 13 means a layer closer to the output than the reference layer among the L layers. The reference layer can be arbitrarily designated, but may be designated as L/2, 2L/3, or the like, for example. The number of layers of the deep layer 13 and the number of inputs X and Yi may be one or plural. The features Fi¹³X and Fi¹³Yi tend to be dominated by the feature components of the data components of the data source i. The deep layer 13 may be the same as or different from the deep layer 12.

Next, the first change detection module 142 of the composition determination unit 14 calculates an evaluation score for evaluating the difference (hereinafter, referred to as a third evaluation score) between the features Fi¹³X and Fi¹³Yi based on the features Fi¹³X and Fi¹³Yi, and determines whether or not the tendency of the data component of the foreground data source i included in the mixed data X has changed based on comparison between the third evaluation score and a threshold (hereinafter, referred to as a third threshold). As the third evaluation score, the degree of divergence between the features Fi¹³X and Fi¹³Yi (hereinafter, a third divergence degree) is used. The first change detection module 142 determines that the tendency of the data component of the foreground data source i included in the mixed data X has changed in a case where the third divergence degree is larger than the third threshold, and determines that the tendency of the data component of the foreground data source i included in the mixed data X has not changed in a case where the third divergence degree is smaller than the third threshold.

The type of the third divergence degree can be arbitrarily selected according to a combination of the number of features Fi¹³X and the number of features Fi¹³Yi. The number of each of the features Fi¹³X and Fi¹³Yi can be arbitrarily set according to the number of layers of the deep layer 13 and the number of input data. In other words, in a case where the number of layers, X, and Yi of the deep layer 13 is one, the number of the features Fi¹³X and Fi¹³Yi is one, and in a case where any of the number of layers, X, and Zi of the deep layer 13 is more than one, the number of the features Fi¹³X and Fi¹³Yi is one or more. Specifically, in a case where the number of features Fi¹³X is one and the number of features Fi¹³Yi is one, the Euclidean distance, the Manhattan distance, the cosine similarity, and the like may be selected as the divergence degree. In a case where the number of features Fi¹³X is one and the number of features Fi¹³Yi is plural, or in a case where the number of features Fi¹³X is plural and the number of features Fi¹³Yi is one, the Mahalanobis distance, the Gaussian mixture model, the kernel density estimation, or the like may be selected as the divergence degree. In a case where the number of features Fi¹³X is plural and the number of features Fi¹³Yi is plural, the maximum mean discrepancy, the Kullback-Leibler divergence, and the like may be selected as the divergence degree.

As the third threshold, a unique threshold embedded in the composition determination unit 14 may be used. Alternatively, a threshold designated by a user or the like may be used as the third threshold. In this case, the threshold may be calculated based on the known data used at the time of training the individual model Mi and a small number of pieces of evaluation data.

In a case where step SA8 is performed, the composition determination unit 14 decides whether or not all the data sources i have been determined (step SA9). In a case where it is decided that the determination has not been performed for all the data sources i (step SA9: NO), the composition determination unit 14 executes steps SA2 to SA9 for other data sources i for which determination has not been performed. The composition determination unit 14 repeats steps SA2 to SA9 until it is decided that the determination has been made for all the data sources i.

Then, in a case where it is decided in step SA9 that the determination has been performed for all the data sources i (step SA9: YES), the composition determination unit 14 integrates a determination results (D4i) related to step SA6 and determines whether or not the tendency of the data component of the background data source group has changed (step SA10). As a result, the determination result (D3) as to whether or not the tendency of the data component of the background data source group has changed is output.

There are various methods for integrating the determination results (D4i). As an example, the integration module 144 of the composition determination unit 14 determines that the tendency of the data component of the background data source group has changed in a case where it is determined that the tendency of the data component other than the data source i has changed for the predetermined foreground data source i among the determination results (D4i) related to all the foreground data sources i. The predetermined foreground data source i may be designated as the foreground data source of interest, or may be designated as all the foreground data sources i. Since it is not needed to specify the data source included in the background data source group in step SA10, the determination that the tendency of the data component other than the predetermined data source i has changed can be equated with the change in the tendency of the data component of the background data source group.

In a case where there is a plurality of predetermined foreground data sources i, if it is determined that the tendency has changed for any one of the data sources i, the integration module 144 can determine that the tendency of the data component of the background data source group has changed. In a case where there is a plurality of predetermined foreground data sources i, as another example, a majority decision of the determination result may be performed. As an example, in a case where the number of data sources determined to have a change in tendency is larger than the number of data sources determined to have no change in tendency, it is possible to determine that the tendency of the data component of the background data source group has changed.

As another example, the integration module 144 may use the evaluation score calculated in step SA6 to determine whether or not the tendency of the data component of the background data source group has changed. Specifically, the integration module 144 integrates the evaluation scores corresponding to all the data sources i to calculate an integrated score, and determines whether or not the tendency of the data component of the background data source group has changed based on the comparison between the integrated score and a threshold. As the integrated score, for example, a sum or a weighted sum of evaluation scores may be used. In a case where the integrated score is larger than the threshold, it may be determined that the tendency of the data component of the background data source group has changed, and in a case where the integrated score is smaller than the threshold, it may be determined that the tendency of the data component of the background data source group has not changed.

In a case where step SA10 is performed, the composition determination unit 14 integrates the determination results D1, D2, and D3 to generate a determination result of the data composition (step SA11). In step SA11, the integration module 144 of the composition determination unit 14 generates information indicating the appropriateness of the six classifications shown in FIG. 4 as the determination result of the data composition.

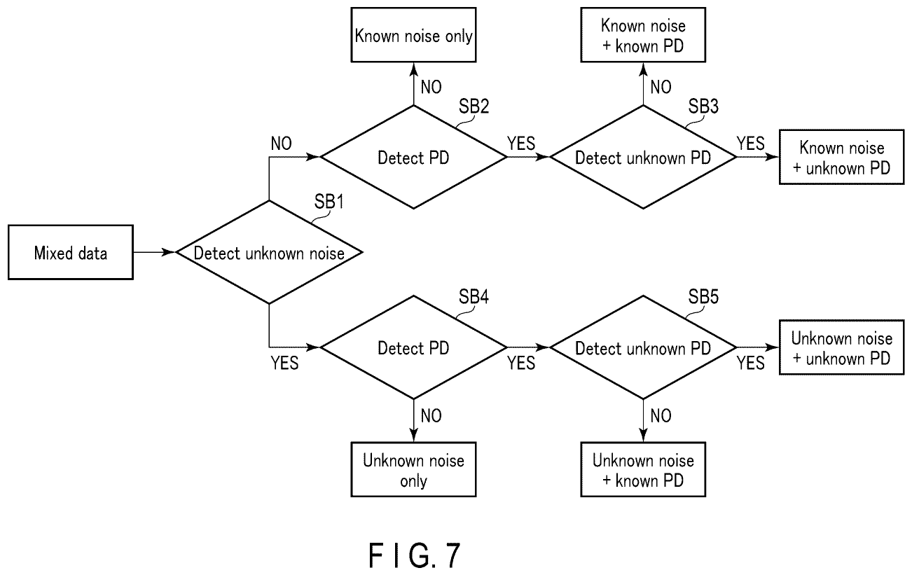

FIG. 7 is a diagram showing a determination process of six classifications of data compositions in a case where N=1 and M=1. In the example of FIG. 7, it is assumed that the data source of the foreground data is a partial discharge (PD) corresponding to an abnormal signal, and the data source of the background data is a noise signal. As shown in FIG. 7, first, it is determined whether or not unknown noise is detected from the mixed data according to the determination result (D3) of step SA10 (step SB1). In a case where the tendency of the data component of the background data source group has not changed, it means that the noise component included in the mixed data is known and, in a case where the tendency of the data component of the background data source group has changed, it means that the noise component included in the mixed data is unknown. Note that it is assumed that the mixed data always includes noise.

In a case where it is determined that the unknown noise is not detected (step SB1: NO), it is determined whether or not the data component of the PD (hereinafter, referred to as a PD component) is detected from the mixed data according to the determination result (D1) of step SA7 (step SB2). In a case where the PD component is not detected (step SB2: NO), a determination result of the data composition indicating that only the known noise component is included in the mixed data is output.

In a case where it is determined that the PD component is detected from the mixed data (step SB2: YES), it is determined whether or not the PD component is unknown according to the determination result (D2) of step SA8 (step SB3). In a case where the tendency of the PD component has not changed, it is determined that the PD component is known (step SB3: NO). In this case, the determination result of the data composition indicating that the mixed data includes the known noise component and the known PD component is output. On the other hand, in a case where the tendency of the PD component changes, it is determined that the PD component is unknown (step SB3: YES). In this case, the determination result of the data composition indicating that the mixed data includes the known noise component and the unknown PD component is output.

In a case where it is determined that the unknown noise is detected (step SB1: YES), it is determined whether or not the PD component is detected from the mixed data according to the determination result (D1) of step SA7 (step SB4). In a case where the PD component is not detected (step SB4: NO), it is determined that only the unknown noise component is included in the mixed data.

In a case where it is determined that the PD component is detected from the mixed data (step SB4: YES), it is determined whether or not the PD component is unknown according to the determination result (D2) of step SA8 (step SB5). In a case where the tendency of the PD component has not changed, it is determined that the PD component is known (step SB5: NO). In this case, a determination result of the data composition indicating that the mixed data includes an unknown noise component and a known PD component is output. On the other hand, in a case where the tendency of the PD component changes, it is determined that the PD component is unknown (step SB5: YES). In this case, the determination result of the data composition indicating that the mixed data includes the unknown noise component and the unknown PD component is output.

In a case where step SA11 is performed, the display control unit 15 displays the determination result of the data composition output in step SA11 on the display device 4 (step SA12). A display screen of the determination result of the data composition can be designed into an arbitrary layout.

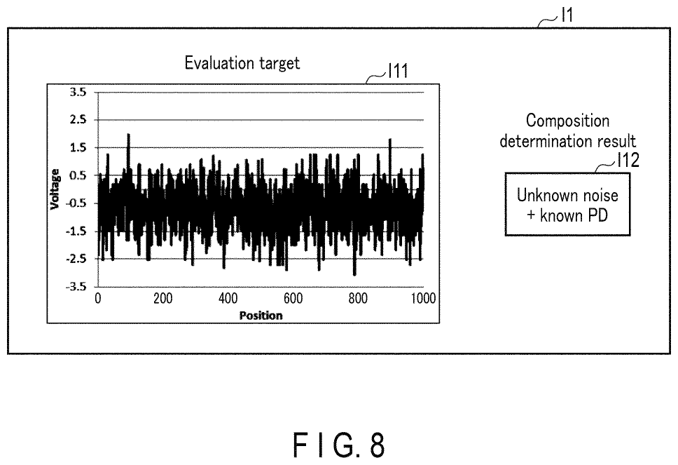

FIG. 8 is a diagram showing an example of a display screen I1 of the determination result of the data composition. The display screen I1 is displayed on the display device 4. The display screen I1 includes, for example, a first display field Ill and a second display field 112. In the first display field Ill, the mixed data X to be determined is displayed. In the second display field 112, the determination result of the data composition output in step SA11 is displayed. As an example, a character string, such as “unknown noise+known PD”, which means the determination result of the data composition corresponding to step SB5: NO in FIG. 7, “the mixed data includes an unknown noise component and a known PD component” may be displayed. As a result, the user can grasp the determination result of the data composition of the mixed data X. In addition, by displaying the mixed data X and the determination result of the data composition side by side, it is possible to visually recognize the determination target and measure the reliability of the determination result of the data composition.

With the above, the data composition determination process ends.

Note that the processing procedure of the data composition determination process shown in FIG. 5 is an example, and the present embodiment is not limited thereto. For example, the order of the acquisition process (SA1) of the mixed data X, the acquisition process (SA2) of the mixed data Yi, and the acquisition process (SA3) of the mixed data Zi is not limited to this order, and may be any order. As another example, the order of the determination step (SA6), the determination step (SA7), and the determination step (SA8) is not limited to this order, and may be any order.

As another example, the feature is calculated for each of all the layers included in the individual model Mi in step SA5, but the feature may be calculated only for the layers used in the determination step (SA6), the determination step (SA7), and the determination step (SA8).

As another example, in step SA6, the presence or absence of a change in the tendency of the data components other than the data source i is determined based on the features Fi¹¹X and Fi¹¹Yi of the shallow layer 11. However, the present embodiment is not limited thereto, and the determination may be performed based on the features Fi¹⁴X and Fi¹⁴Yi of the layer 14 other than the shallow layer 11. Similarly, in step SA7, the presence or absence of the data source i is determined based on the features Fi¹²X and Fi¹²Yi of the deep layer 12. However, the present embodiment is not limited thereto, and the determination may be performed based on the features Fi¹⁴X and Fi¹⁴Yi of the layer 14 other than the deep layer 12. Similarly, in step SA8, the presence or absence of a change in tendency of the data component of the data source i is determined based on the features Fi¹³X and Fi¹³Yi of the deep layer 13. However, the present embodiment is not limited thereto, and the determination may be performed based on the features Fi¹⁴X and Fi¹⁴Yi of the layer 14 other than the deep layer 13.

As another example, in steps SA2 and SA3, Yi and Zi are generated such that the background data source is a main component in addition to the foreground data source i. However, the present embodiment is not limited thereto, and the foreground data source j different from the data source i may be generated as a main component. Such a generation method is useful in a case where another foreground data source j frequently occurs and/or determines data included in a large amount.

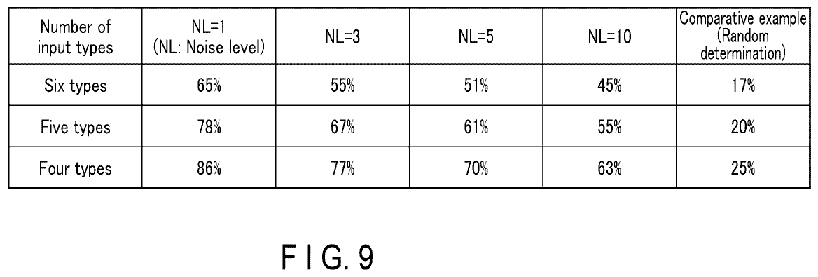

FIG. 9 is a diagram showing evaluation of determination results of the data compositions according to the present embodiment. As shown in FIG. 9, a performance index is indicated for each combination of the number of input types and a noise level (NL). The number of input types shown in FIG. 9 means the number of classifications of the data compositions of the mixed data. The “six types” represents the six types shown in FIG. 7. The “five types” represents those that do not distinguish known and unknown PD components (not distinguish the presence or absence of a change in the tendency of the data component, in other words) with respect to unknown noise among the six types described above. The “four types” mean that the presence or absence of the PD component is not distinguished (not include PD component, in other words) with respect to the unknown noise among the six types described above. The noise level means the intensity of the noise component with respect to the PD component. Specifically, the noise level means a ratio of the maximum amplitude of the noise component to the maximum amplitude of the PD component. The comparative example is an example in which random determination different from the present embodiment is performed. As the performance index, an average accuracy rate of various inputs is used.

As shown in FIG. 9, the performance index tends to deteriorate as the number of input types and the noise level increase. However, it can be seen that in the method according to the present embodiment, the performance index is improved for any number of input types as compared with the comparative example. Therefore, according to the present embodiment, it is possible to improve the determination performance of the data composition.

As described above, the data composition determination process has been described with reference to FIGS. 5 to 8, but these are merely examples, and various elements can be added, deleted, and/or changed.

### First Modification

In the above embodiment, features Fi^{12,13}X, Fi^{12,13}Yi and Fi^{12,13}Zi from the deep layers 12 and 13 are used in steps SA7 and SA8. The feature calculation unit 13 according to the first modification may use features Fi^{12,13}X, Fi^{12,13}Yi and Fi^{12,13}Zi from the deep layers 12 and 13 obtained by processing to the features Fi¹¹X, Fi¹¹Yi, and Fi¹¹Zi from the shallow layer 11 and propagating the processed features to subsequent layers. As an example, the feature calculation unit 13 may extract the residual feature by subtracting the spatial average difference of the feature Fi¹¹X from the feature Fi¹¹X, generate features (hereinafter, referred to as synthesized features) by adding the feature Fi¹¹Zi to the residual feature, and calculate the features Fi^{12,13}X, Fi^{12,13}Yi, and Fi^{12,13}Zi from the deep layers 12 and 13 by propagating the composite feature to the layers after the shallow layer 11.

Furthermore, the magnitude of the residual feature may be used for determining whether or not the foreground data source i is included.

### Second Modification

In the above embodiment, the feature calculation unit 13 performs processing independently for each data source i. The feature calculation unit 13 according to a second modification may perform common processing between different data sources i. As an example, the feature calculation unit 13 may perform common processing for converting the mixed data X, Yi, and Zi into features suitable for extraction, and input each of the mixed data X, Yi, and Zi subjected to the common processing to a plurality of individual models Mi corresponding to a plurality of data sources i.

In the above embodiment, all the individual models Mi have the same number of layers L, but may have different numbers of layers for each data source i. It is expected to have high performance by individually designing the individual model Mi according to the property of the extracted data.

### Third Modification

In the above embodiment, in order to determine whether or not there is a change in the tendency of the data component of the background data source group in step SA10, the composition determination unit 14 determines whether or not there is a change in the tendency of the data component other than the data source i in step SA6. However, the present embodiment is not limited thereto. The composition determination unit 14 according to a third modification may determine whether or not the tendency of the data component other than the arbitrary data source i has changed based on the features Fi¹¹X and Fi¹¹Yi of the shallow layer 11, and use the determination result as the determination result of the presence or absence of the change in the tendency of the data component of the background data source group. In this case, in a case where the tendency of the data component other than the arbitrary data source i has changed, it is determined that the tendency of the data component of the background data source group has changed, and in a case where the tendency of the data component other than the arbitrary data source i has not changed, it is determined that the tendency of the data component of the background data source group has not changed.

### Fourth Modification

In the above embodiment, the order of processing the data source i to be determined is not particularly limited. However, the present embodiment is not limited thereto, and the order of processing the data source i to be determined may be limited according to an arbitrary criterion. As an example, data sources that tend to be included in a large amount of current data may be processed in order. The order of the data sources to be processed may be determined according to other criteria.

### Fifth Modification

In the fourth modification, the order of processing the data source i to be determined is designated. The composition determination unit 14 according to a fifth modification may adjust the first threshold, the second threshold, and the third threshold used in the determination processing (SA6, SA7, SA8) on the data source in the current iteration based on the first threshold, the second threshold, and the third threshold used in the determination processing (SA6, SA7, SA8) on another data source in the previous iteration, instead of designating the order of processing the data source to be determined.

### Sixth Modification

The composition determination unit 14 according to a sixth modification sequentially executes processing of the signal source determination module 141, the first change detection module 142, and the second change detection module 143, and determines a determination threshold (first threshold, second threshold, and third threshold) or an evaluation score (first evaluation score, second evaluation score, and third evaluation score) of a subsequent module according to a determination result by an executed module among the signal source determination module 141, the first change detection module 142, and the second change detection module 143. The order of processing of the signal source determination module 141, the first change detection module 142, and the second change detection module 143 is not particularly limited, but the composition determination unit 14 according to the sixth modification executes processing in the order of the second change detection module 143, the signal source determination module 141, and the first change detection module 142.

Hereinafter, processing according to the sixth modification will be specifically described. It is assumed that the foreground data source is an abnormal signal and the background data source is noise. The determination of the presence or absence of a tendency change of a noise component, which is a dominant component among various data components included in the mixed data, is performed in advance, and the determination result is used for the determination of the presence or absence of the subsequent abnormality signal. Specifically, in order to perform determination with high accuracy, the composition determination unit 14 switches the second threshold and/or the second evaluation score according to the presence or absence of a change in the tendency of the noise component. As an example, in a case where it is determined that there is a change in the tendency of the noise component, the composition determination unit 14 determines the presence or absence of an abnormal signal based on the residual from the average component of the features of the shallow layer 11. In a case where there is a tendency change in the data component of the data source from the time of learning, the individual model Mi tends to be difficult to appropriately function. In particular, in a case where the training is performed assuming a situation where the intensity of the noise component is strong, the change in the tendency of the noise component greatly affects the determination of the presence or absence of the subsequent abnormality signal. Therefore, in a case where a change in the tendency of the noise component occurs, a method that is robust to the change in the tendency, that is, the above method focusing only on the residual from the average component is preferable from the viewpoint of accuracy.

As described above, the data composition determination apparatus 100 according to the embodiment includes the mixed data acquisition unit 11, the model acquisition unit 12, the feature calculation unit 13, and the composition determination unit 14. The mixed data acquisition unit 11 acquires mixed data to be determined in which data components from a plurality of data sources are mixed. The model acquisition unit 12 acquires an individual model including a plurality of layers from an input layer to an output layer. The composition determination unit 14 applies the mixed data to the individual model, and calculates a feature of the mixed data for each of some or all of the layers. The composition determination unit 14 determines the composition of the data source of the data components constituting the mixed data based on the calculated features.

According to the above configuration, by introducing the determination method appropriately using the multilayer structure of the information processing, it is possible to determine which data component of which data source is included in the mixed data and to determine the change in the tendency of the included data component with high accuracy. In addition, since information of all layers is not used, it is possible to improve maintainability of data processing by simplifying determination processing, that is, to realize easy and stable long-term operation.

Thus, according to the present embodiment, it is possible to determine the composition of data in which data components from a plurality of data sources are mixed with high accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data composition determination apparatus comprising a processor that:
acquires mixed data to be determined in which data components from a plurality of data sources are included;
acquires a model including a plurality of layers from an input layer to an output layer;
applies the mixed data to the model to calculate a feature of the mixed data for each of some or all of the layers; and
determines a composition of the data sources of the data components constituting the mixed data based on the calculated feature.

2. The data composition determination apparatus according to claim 1, wherein
each of the data sources belongs to any one of a foreground data source group and a background data source group,
the foreground data source group includes one or more foreground data sources, and each of the one or more foreground data sources is individually determined whether or not a data component of the foreground data source is included in the mixed data and whether or not a tendency of the data component of the foreground data source has changed,
the background data source group includes one or more background data sources, and each of the one or more background data sources is not individually determined whether or not a data component of the background data source is included in the mixed data, but is determined whether or not a tendency of any data component of the one or more background data sources has changed, and
the processor determines whether or not the mixed data includes any of the foreground data source belonging to the foreground data source group, whether or not the tendency of the data component of the foreground data source has changed, and whether or not the tendency of the data component of the background data source group included in the mixed data has changed.

3. The data composition determination apparatus according to claim 2, wherein
the processor includes a signal source determination module, a first change detection module, and a second change detection module,
the signal source determination module determines, for each of the one or more foreground data sources, whether or not the foreground data source is included in the mixed data based on a feature from a first designated layer among the layers,
the first change detection module determines, for each of the one or more foreground data sources, whether or not the tendency of the data component of the foreground data source included in the mixed data has changed based on a feature from a second designated layer among the layers, and
the second change detection module determines whether or not the tendency of the data component of sources other than the foreground data source included in the mixed data has changed based on a feature from a third designated layer among the layers, and determines whether or not the tendency of the data component of the background data source group included in the mixed data has changed by integrating determination results based on features from the third designated layer regarding the one or more foreground data sources.

4. The data composition determination apparatus according to claim 3, wherein
the processor acquires first other mixed data in which a data source other than the foreground data source is dominant regarding each of the one or more foreground data sources, and calculates a feature of the first other mixed data from the first designated layer by applying the first other mixed data to the model regarding each of the one or more foreground data sources, and
the signal source determination module calculates an evaluation score for each of the one or more foreground data sources based on the feature of the mixed data from the first designated layer and the feature of the first other mixed data, and determines whether or not the foreground data source is included in the mixed data based on comparison between the evaluation score and a threshold.

5. The data composition determination apparatus according to claim 4, wherein
the first designated layer is a layer closer to an output than a reference layer among the layers, and
the evaluation score is a divergence degree between the feature of the mixed data and the feature of the first other mixed data, or a residual from a temporal and/or spatial average of the feature of the mixed data.

6. The data composition determination apparatus according to claim 3, wherein
the processor acquires second other mixed data in which the foreground data source is dominant regarding each of the one or more foreground data sources, and calculates a feature of the second other mixed data from the second designated layer by applying the second other mixed data to the model regarding each of the one or more foreground data sources, and
the first change detection module calculates an evaluation score for each of the one or more foreground data sources based on the feature of the mixed data from the second designated layer and a feature of the second other mixed data, and determines whether or not the tendency of the data component of the foreground data source included in the mixed data has changed based on comparison between the evaluation score and a threshold.

7. The data composition determination apparatus according to claim 6, wherein
the second designated layer is a layer closer to an output than a reference layer among the layers, and
the evaluation score is a divergence degree between the feature of the mixed data and the feature of the second other mixed data.

8. The data composition determination apparatus according to claim 3, wherein
the processor acquires second other mixed data in which the foreground data source is dominant regarding each of the one or more foreground data sources, and calculates a feature of the second other mixed data from the third designated layer by applying the second other mixed data to the model, and
the second change detection module calculates an evaluation score based on a feature of the mixed data from the third designated layer and a feature of the second other mixed data, and determines whether or not the tendency of the data component of sources other than the foreground data source included in the mixed data has changed based on comparison between the evaluation score and a threshold.

9. The data composition determination apparatus according to claim 8, wherein
the third designated layer is a layer closer to an input than a reference layer among the layers, and
the evaluation score is a divergence degree between the feature of the mixed data and the feature of the second other mixed data.

10. The data composition determination apparatus according to claim 3, wherein
the processor
sequentially executes processing of the signal source determination module, the first change detection module, and the second change detection module, and
decides a threshold for determination in a subsequent module according to a determination result by an executed module among the signal source determination module, the first change detection module, and the second change detection module.

11. The data composition determination apparatus according to claim 10, wherein the processor executes processing in order of the second change detection module, the signal source determination module, and the first change detection module.

12. The data composition determination apparatus according to claim 1, wherein the model is provided for each of the one or more data sources.

13. The data composition determination apparatus according to claim 12, wherein the model is optimized based on data of the corresponding data source so as to maximize a matching degree with information of the corresponding data source.

14. The data composition determination apparatus according to claim 2, wherein the processor determines, as the composition, a first composition in which only a data component of a known background data source group is included in the mixed data, a second composition in which a data component of a known background data source group and a data component of a known foreground data source are included in the mixed data, a third composition in which a data component of a known background data source group and a data component of an unknown foreground data source are included in the mixed data, a fourth composition in which only a data component of an unknown background data source group is included in the mixed data, a fifth composition in which a data component of an unknown background data source group and a data component of a known foreground data source are included in the mixed data, and a sixth composition in which a data component of an unknown background data source group and a data component of an unknown foreground data source are included in the mixed data.

15. The data composition determination apparatus according to claim 2, wherein
the foreground data source group includes a foreground data source, and
the background data source group includes a background data source.

16. The data composition determination apparatus according to claim 2, wherein
the one or more foreground data sources are abnormal component generation sources, and
the one or more background data sources are noise component generation sources.

17. The data composition determination apparatus according to claim 16, wherein
the abnormal component is unsteadily generated during a measurement period of the mixed data, and
the noise component is constantly generated during the measurement period.

18. The data composition determination apparatus according to claim 1, wherein the processor displays the determined composition on a display device.

19. A data composition determination method executed by a processor, the method comprising:
acquiring mixed data to be determined in which data components from a plurality of data sources are included;
acquiring a model including a plurality of layers from an input layer to an output layer;
applying the mixed data to the model to calculate a feature of the mixed data for each of some or all of the layers; and
determining a composition of the data sources of the data components constituting the mixed data based on the calculated feature.

20. A non-transitory computer readable storage medium including computer executable instructions, wherein the instructions, when executed by a processor, cause the processor to perform operations comprising:
acquiring mixed data to be determined in which data components from a plurality of data sources are included;
acquiring a model including a plurality of layers from an input layer to an output layer;
applying the mixed data to the model to calculate a feature of the mixed data for each of some or all of the layers; and
determining a composition of the data sources of the data components constituting the mixed data based on the calculated feature.
